(19) United States
(12) Patent Application Publication
(10) Pub. No.: US 2010/0107095 A1
(43) Pub. Date: Apr. 29, 2010

(54) TEMPLATE-BASED CALCULATOR APPLICATION

(75) Inventors: Gokul Singh, Hyderabad (IN); Riyaz Mohamed Pishori, Hyderabad (IN); Mahesh Tharamal, Hyderabad (IN); Chetan A. Parulekar, Hyderabad (IN); Purushottam Madhukar Kulkarni, Hyderabad (IN)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/258,053

(22) Filed: Oct. 24, 2008

(51) Int. Cl. G06F 3/048

(52) U.S. Cl. 715/764

(57) ABSTRACT

Methods, systems, and media are provided for using a calculator application to calculate answer values by evaluating formulas based on user input. The calculator application is hosted by an operating system and includes a template store containing templates that define user interface elements such as input fields associated with variables. The templates also have embodied therein formulae that define relationships between the variables. A user-interface, generated from information in a template, is provided to a user that includes input fields for receiving values to be associated with variables. Answer values are calculated by evaluating the formulae based on user input.

### BACKGROUND

Operating systems commonly include calculator applications that are adapted for performing simple calculations. Users typically need to purchase special calculators for performing more complex business, financial, scientific, and statistical calculations. Other options for performing these calculations can include spreadsheets and the like, but these options can be cumbersome and less efficient than operating-system-based calculators.

### SUMMARY

Embodiments of the invention are defined by the claims below, not this summary. A high-level overview of embodiments of the invention are provided here for that reason, to provide an overview of the disclosure.

Embodiments of the present invention provide systems and methods for using a calculator application hosted by an operating system to calculate answer values based on formulas. Formulas represent relationships between variables and are embodied in template files located in a template store hosted by the operating system. The calculator application provides a selection of various types of formulas such as, for example, statistical formulas, physics formulas, financial formulas, accounting formulas, and units conversion formulas.

According to embodiments of the present invention, upon instantiation of the calculator application, a user interface is provided which includes a listing of formula identifiers from which a user can choose. Formula identifiers correspond to formulas embodied in template files and generally take the form of recognizable names commonly associated with formulas. Upon selecting a desired formula for calculation, a user interface is provided that includes input fields for receiving user input defining values for one or more variables associated with the formula. In embodiments, the input fields include labels and units and in some embodiments, the input fields can contain a listing of units from which the user can choose. Input is received from the user and the formula is evaluated based on the user input. Answer values can be displayed in input fields and can be cached for use in subsequent calculations.

In various embodiments of the present invention, the calculator application references templates that include input field characterizations and embodiments of formulas for providing the user interfaces and calculation functionalities described herein. In embodiments, templates can be built-in, user-defined, or received from a third-party template source such as an application. In some embodiments, templates can reference other templates, and can be strung together to create more complex calculations.

### BRIEF DESCRIPTION OF THE SEVERAL VIEWS OF THE DRAWINGS

Illustrative embodiments of the present invention are described in detail below with reference to the attached drawing figures, which are incorporated by reference herein and wherein:

FIG. 1 is a block diagram showing an exemplary computing device in accordance with an embodiment of the present invention;

FIG. 2 is a block diagram showing an exemplary calculator system in accordance with an embodiment of the present invention;

FIG. 3 is a schematic diagram showing an exemplary calculator instantiation process according to an embodiment of the present invention;

FIG. 4 is a schematic diagram showing an exemplary calculator according to an embodiment of the present invention;

FIGS. 5-8 depict an exemplary calculation experience with a user interface in accordance with an embodiment of the present invention;

FIG. 9 depicts an exemplary user interface associated with a mortgage estimation calculation in accordance with an embodiment of the present invention; and

FIGS. 10-13 are flow diagrams showing illustrative methods of using a calculator application to calculate an answer value according to a formula embodied on a template in accordance with an embodiment of the present invention.

### DETAILED DESCRIPTION

Embodiments of the present invention relate to using a calculator application to calculate an answer value by applying a formula having at least one variable according to input received from a user.

In a first illustrative aspect, a calculator application, hosted by an operating system, is instantiated and provides a user interface that includes various input fields for receiving user input defining values for variables associated with a formula. The formula is evaluated based on the user input to determine an answer value, which is displayed to the user.

In another illustrative aspect, a first user interface is provided and includes a listing of formulas available for performing calculations. The formulas are represented by formula identifiers and are embodied on templates maintained in a template store hosted by the operating system. A user can select from among the available templates. Upon receiving a user selection of a formula, a template corresponding to that formula is referenced to provide input fields on a second user interface. The input fields are generated by referencing input field characterizations in the template and are configured to receive user input defining values that can be associated with variables. The formula is also referenced and a calculable model representing the formula is generated so that the formula can be evaluated by a calculation engine. User input is received and an answer value is calculated.

In a third illustrative aspect of the present invention, templates can be built-in, defined by the user, or received from a third party. User-defined and third-party templates are received into the template store and can be referenced upon a user selection of a formula corresponding to the template. A user interface generator peruses the template store to generate a listing of all the available templates and provides that listing such that a user can select a desired template for calculation. Upon receiving a selection of a particular formula, the corresponding template is referenced to generate a calculable model of the formula embodied thereon and input field characterizations are referenced to generate a form-based user interface. Additional templates can be referenced from a first template as well, and answer values from additional templates can be subsequently used as input in the templates.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, and the like. The invention may also be practiced in distributed computing environments where tasks are performed by remote-processing devices that are linked through a communications network.

Computer-readable media include both volatile and nonvolatile media, removable and nonremovable media, and contemplates media readable by a database, a switch, and various other network devices. By way of example, and not limitation, computer-readable media comprise media implemented in any method or technology for storing information. Examples of stored information include computer-useable instructions, data structures, program modules, and other data representations. Media examples include, but are not limited to information-delivery media, RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently.

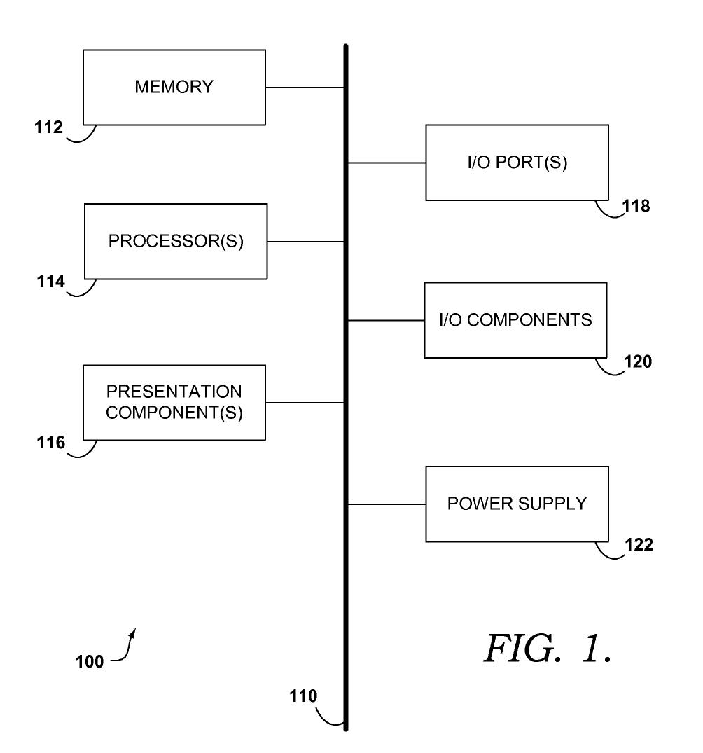

An exemplary operating environment in which various aspects of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

Computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, etc.

I/O ports 118 allow computing device 100 to be logically coupled to other devices including I/O components 120, some of which may be built in. Illustrative components include a microphone, joystick, game pad, satellite dish, scanner, printer, wireless device, keyboard, pen, voice input device, touch input device, touch-screen device, interactive display device, or a mouse.

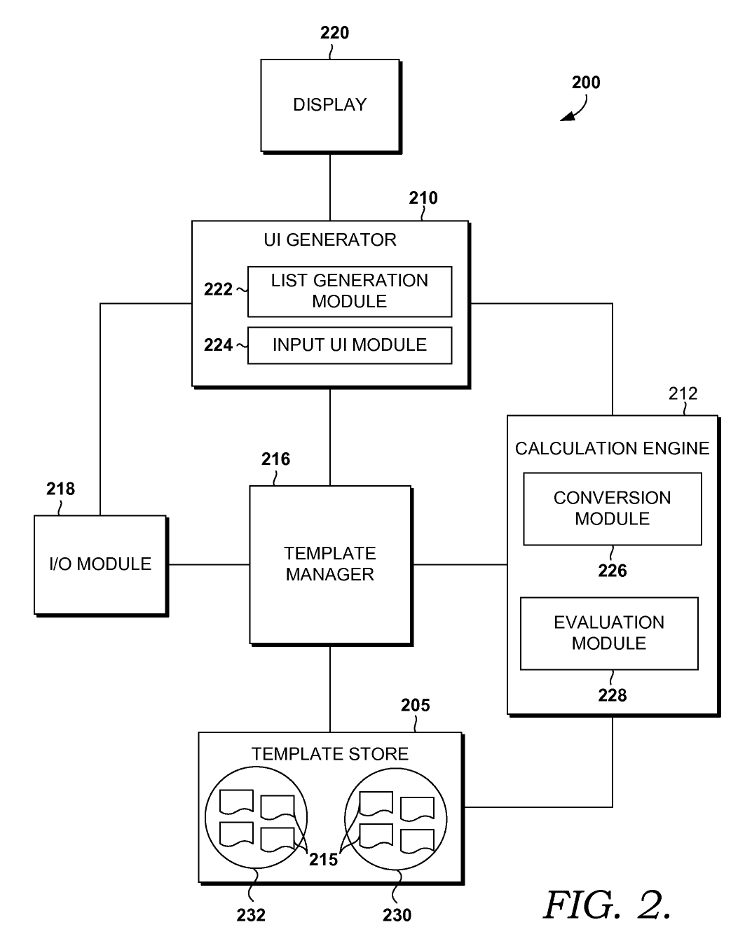

Turning to FIG. 2, an exemplary calculator system 200 in accordance with an embodiment of the present invention is illustrated. Calculator system 200 can be embodied in a computing device such as, for example, computing device 100. Calculator system 200 includes a template store 205, a user-interface (UI) generator 210, a calculation engine 212, and a template manager 216. To facilitate user interaction with calculator system 200, an input/output (I/O) module 218 and a display 220 are also included as illustrated in FIG. 2. Calculator system 200 is merely an example of one suitable calculator system and is not intended to suggest any limitation as to the scope of use or functionality of the present invention. Neither should calculator system 200 be interpreted as having any dependency or requirement related to any single component or combination of components illustrated therein.

Moreover, calculator system 200 is directly hosted by the operating system (not shown in FIG. 2) associated with the computing device on which the calculator system 200 is implemented. Any type of operating system can be used in various implementations of embodiments of the present invention. For example, the operating system can be a WINDOWS operating system, available from Microsoft Corporation of Redmond, Wash. or a MAC OS X operating system, available from Apple, Inc. of Cupertino, Calif. As used herein, the phrase “directly hosted” means that the application, module, engine, component, or the like is hosted by the operating system as an independent application or program module. In other words, the calculator system 200 is adapted to function independently of all other programs or application, as a separate instantiation of a program module. In this way, calculator system 200 can facilitate presentation of a useful computing experience to a user without having to use or rely on another application such as a spreadsheet, thus minimizing processing burdens and storage. Additionally, a user experience with a low, manageable learning curve can be presented within the context of an extensible application that can be modified to accommodate various environments, users, situations, and the like. The extensibility and independence of calculator system 200 facilitate relatively simple and comprehensive changes and customizations without having to interface with another application such as a spreadsheet. Each of the components 205, 210, 212, and 216 are directly hosted by the operating system, as may be various other components and modules not illustrated in FIG. 2.

Template store 205 houses a number of templates 215. In embodiments, template store 205 can be part of the file system located on the computing device on which calculator system 200 is implemented. In an embodiment, templates 215 include characterizations of input fields as well as the formulae which link the fields to one another. Characterizations of input fields (i.e., “input field characterizations”), as used herein, are sets of information, formatted according to the XML standard governing the templates 215, that facilitate rendering (e.g., displaying) the input fields on a display. The characterizations of input fields also can include various parameters, attributes, or other types of metadata that provide information about the variables and their respective roles in the context of the corresponding formula. In embodiments, characterizations of input fields can include parameters that, when utilized by the UI generator 210, cause a UI to be presented that includes the input fields.

In some embodiments, the input field characterizations can specify a particular layout for the UI. For instance, the input field characterizations can define the placement on the screen for each input field, the size of each input field, the shape of each input field, the font to be used for rendering text associated with each input field and the like. Input field characterizations can also specify the type of data that can be received as user input via the input fields. Many other types of information regarding the presentation of the input fields can be included, and are within the ambit of the present invention.

The combination of input fields and a formula linking those fields can be referred to as a template definition. The template definition is stored in the template store 205 as a template. According to various embodiments of the present invention, templates can include structured file formats such as, for example XML files. In other embodiments, templates can be binary files or other types of files suitable for containing information that can be read by components of the calculator application. The information included in the template definition includes all of the information necessary to provide a calculator experience to a user. Additionally, each template can include some type of identifier or identifiers such as, for example, a template name, that can be used by the calculator system 200 to identify the template. Similarly, a template 215 can include a formula identifier that identifies the formula embodied therein. In embodiments, the template identifier and the formula identifier can be the same. In other embodiments, the two identifiers may be different. A template identifier can be used by calculator system 200 to identify particular templates, and a formula identifier can be presented to a user such that the user can identify particular formulas.

In embodiments, a formula identifier can be displayed such that a user can identify the template. This capability is useful for presenting a listing of formula identifiers from which a user can select, based on the user's calculation needs. For example, one template may be designed for calculating present value given a future value, period of time, and/or other variables. Such a template could include a formula identifier such as “Present Value.” In embodiments, template store 205 is customizable in that a user can modify formula identifiers to suit the user's preferences. For instance, a user may commonly use two or three formulas and have become accustomed to a particular manner of identifying the formulas. As an example, a user may commonly calculate annual percentage yield, present value, and future value. Formula identifiers corresponding to those formulas might include “Annual Percentage Yield,” “Present Value,” and “Future Value,” respectively. Instead, the user may prefer to modify those identifiers such that a listing of formula identifiers may include “APY,” “PV,” and “FV,” respectively. Template store 205 can, in embodiments, support various other types of user modifications as well. For example, in some embodiments, users can modify UI layouts to create a custom experience and in other embodiments, users can define references within a template that target other templates.

Template store 205 is adapted to provide access to templates 215 and in some embodiments, can include functionality that enables users to modify template definitions. In an embodiment, template store 205 enables addition and deletion of templates 215. For example, template store 205 can include built-in templates 230 that are pre-defined and that can be used to perform various types of known calculations. Template store 205 can also include user-defined or third-party templates 232. As used herein, users can include users that invoke the calculator system 200 to request that calculations be performed given user input such as values of independent variables. Third-parties can also invoke calculator system 200 to request calculations. For example, third-parties can include entities that provide template definitions to template store 205. In that context, a third-party can include a human being, another computing device, a mobile device, a plug-in, an application, and the like.

User-defined and third-party templates 232 can provide for evaluation of any type of function that can be represented by a formula or series of formulae provided in a template. In some embodiments, an application hosted by the operating system can provide template store 205 with template definitions. For example, a business application can include various types of functions and modules that may rely on evaluation of a formula to achieve an answer value. Often, applications will include built-in functionality for evaluating such formulae, however, the calculator system 200 of the present invention can allow for evaluations of formulae to be performed outside of the context of the business application. That way, processing burdens, as well as programming complexity associated with another application can be minimized. Data can be provided as input to the calculator system 200 by an application, a formula can be evaluated, and an answer value or values can be returned to the application.

In embodiments, a user can add a template definition to template store 205 by invoking a template manager 216. Template manager 216 can be implemented in a variety of manners. In embodiments, template manager 216 is adapted to manage the organization, addition, deletion, and modification of templates 215 in template store 205. Template manager 216 can be invoked to perform various other operations such as, for example, inserting references in templates 215 to other templates 215, combining templates 215, modifying templates 215, allowing applications and other software to add templates 215 to the template store 205, and the like.

In an embodiment, template manager 216 can be an application programming interface (API) that enables a user to interact with template store 205 using standard operating system folder commands and techniques. In other embodiments, template manager 216 is not an API, but rather is a control module that operates directly on template store 205. Template manager 216 can be adapted to provide user interfaces that facilitate user management of templates 215 in template store 216. For example, in an embodiment, a user is provided with a user interface that includes representations of folders associated with template store 205 as well as other folders. A user can add templates 215 to template store 205 by dragging the templates from a source folder into a folder associated with template store 205. According to embodiments of the present invention, users can communicate with template manager 216 via an input/output (I/O) module 218.

In another embodiment, template manager 216 includes a program module that assists a user in creating a template 232. The program module can take various forms, and in some embodiments, can provide a user interface that presents prompts for user input, thereby guiding the user through the template creating process. In other embodiments, the program module can include a coding environment for generating XML files, other structured files, or binary files. In still further embodiments, the program module can include various types of graphics, text, prompts, and the like that assist a user in creating a template according to, for example, XML specifications such that the calculator system 200 can utilize the template.

According to an embodiment of the present invention, template manager 216 can include any one or more of the above-described functionalities, including any number of others that facilitate introduction of new templates 215 to template store 205. As indicated above, a user, in the context of the present invention, can include program modules, applications, operating systems, and the like. In one embodiment, an application such as, for example, an instance of accounting software or financial planning software, can be configured to utilize the calculator system 200 residing in the operating system that hosts both applications. In this manner, the application can issue calls for operations to calculator system 200 and receive answer values in return, thereby avoiding the necessity of programming calculating functionality directly into the application.

In the above-described embodiment, the application can interact with template manager 216 to create third-party templates 232 that include formulas for calculating answer values that can be used by the application. In one embodiment, the application can be pre-programmed to create templates that are compatible with the calculator system 200, and the application uses template manager 216 to transfer templates 232 to template store 205. In another embodiment, template manager 216 can receive information from the application about formulas and input fields to be included in a user-defined template 232. Using the information, template manager 216 can create a third-party template 232. In this way, the application or other type of user does not need to include the capability of creating compatible templates 232, but so long as the application or other type of user can communicate information in some recognizable format to the template manager 216.

Similarly, human users of calculator system 200 can manage templates 215 in template store 205 such as, for example, by adding, deleting, modifying, or organizing templates 215. In embodiments, user-defined templates 232 include any templates that are not built-in to the calculator initially. Thus, for example, users can obtain templates 232 from any number of sources such as, for example, from a content provider over the Internet, from a portable storage device, and the like. In embodiments, users can invoke template manager 216 for facilitating the transfer of user-defined templates 232 into template store 205. In other embodiments, users can invoke template manager 216 to facilitate creating user-defined templates 232 as described above.

According to various embodiments of the present invention, template manager 216 serves additional functions. For example, in some embodiments, template manager 216 provides a uniform interface between any number of the other components illustrated in FIG. 2. In an embodiment, template manager 216 can include components such as UI generator 210, calculation engine 212, and I/O module 218. In other embodiments, template manager 216 can be independent of other components. Template manager 216 can be adapted to provide any of the various functionalities described herein with respect to the calculator system 200.

In one embodiment, template manager 216 interfaces with a resource file (not shown in FIG. 2) and is adapted to utilize various libraries, executable files, and the like to provide functionality to components of calculator system 200. For example, in an embodiment, template manager 216 reads templates from the resource file that are configured for unit conversion operations. In other embodiments, template manager 216 can be adapted to parse templates and create data structures (e.g., template objects) representing the contents of templates. These template objects can be stored by calculator system 200. Data input received from users such as values associated with input fields can also be stored in the template objects such that users can recall the data that they previously entered. Answer values calculated according to formulae in templates can be stored as well such that users can utilize the answers in subsequent calculations, return to previous calculations, and the like. In embodiments, template objects, user input, and answer values can be stored temporarily such as for the life of a calculator session. In other embodiments, more permanent storage may be implemented.

Template manager 216 can also be adapted, in some embodiments, to provide mechanisms for querying template store 205 or other storage components for templates, objects, and the like. In further embodiments, template manager 216 can provide mechanisms for querying for details associated with a template such as, for example, template category, arguments, formulas, input fields, and the like. In still further embodiments, template manager 216 provides an interface to convert expression strings to corresponding reduced formulas and providing those reduced formulas to other templates, calculation engine 212, and the like.

Referring again to FIG. 2, UI generator 210 generates UIs and causes them to be presented on display 220. In embodiments, UI generator 210 ascertains UI parameters from templates 215 within template store 205. UI parameters can include any number of different types of attributes, definitions, instructions, characterizations, and the like and are used by UI generator 210 to render a UI on the display 220 that enables user interaction with the calculator system 200. As illustrated in FIG. 2, UI generator 210 includes a list generation module 222 and an input UI module 224.

List generation module 222 peruses template store 205 to generate a listing of formula identifiers. In an embodiments, a template 215 can also include template identifiers that can be used internally to identify templates 215. Accordingly, in some embodiments, list generation module 222 also creates a mapping between formula identifiers and template identifiers and associates that mapping with a listing of formula identifiers. When a user selects a formula identifier, UI generator 210 can reference the mapping to identify the corresponding template identifier. Using the template identifier, UI generator 210 can access the appropriate template 215. List generation module 222 can generate lists according to any number of methods known in the art. Additionally, in embodiments, list generation module 222 can retrieve each template 215 from template store 205 and extract information for the listing. In other embodiments, list generation module 222 is adapted to peruse template store 205 and extract information without having to retrieve the templates 215. List generation module 222 interfaces with a UI engine (not shown) to cause the listing of formula identifiers to be presented on display 220.

With continued reference to FIG. 2, as illustrated therein, UI generator 210 also includes an input UI module 224. Input UI module 224 can cooperate with I/O module 218 to receive and interpret user input. User input can include keystrokes, mouse actions, button actions, and the like. In an embodiment user input includes values to be assigned to variables, and in other embodiments, user input includes selections such as selections of information from a drop-down menu.

Input UI module 224 module is also adapted for generating a UI that can be presented to a user, as described above. Input UI module 224 receives input field characterizations and other attributes or parameters from a template 215. Input UI module 224 interprets the information obtained from the template 215 and renders a UI based on that information. Input UI module 224 is also adapted to receive user input via input fields. Input UI module 224 receives user input, interprets the input, and routes the information to the proper destination. In embodiments, input UI module 242 receives user input that includes values and transfers that user input to calculation engine 212, which can use the information, which may include one or more attributes, to generate and manage a user interface. Based on the input and accompanying data, the Calculation engine 212 evaluates the formula and passes an answer value through input UI module 222 to be rendered on display 220.

As illustrated in FIG. 2, calculation engine 212 includes conversion module 226 and evaluation module 228. Conversion module 226 references each of the templates 215 from template store 205 and generates a mathematical model corresponding to the formula in each template 215. A mathematical model, as used herein, is a calculable (with respect to calculator system 200) representation of the formula and is evaluated using evaluation module 228. In embodiments, conversion module 226 can append a template identifier and/or formula identifier to a mathematical model such that the appropriate model can be accessed during a user session with calculator system 200.

Also, in various embodiments, conversion module 226 can resolve references to other templates, as described above. For example, a template designed for performing unit conversions may be provided. If a user elects to convert from miles to meters, the template may (depending on its design) be configured to convert from miles to kilometers, in which case the additional conversion from kilometers to meters is necessary. To adequately handle situations like this one, the calculator system 200 is adapted to be intelligent enough to recognize situations like this and to know how to handle them. For instance, upon encountering the situation described above, conversion module 226 can retrieve an additional model such as a model for converting kilometers to miles. Conversion module 226 can incorporate the second model into the first and calculate the aggregated model. In other embodiments, conversion module 226 calculates an intermediate answer value using a first one of the models and uses the intermediate value as input in the other model to calculate an answer value. Other techniques for resolving references exist, and all are within the ambit of the present invention.

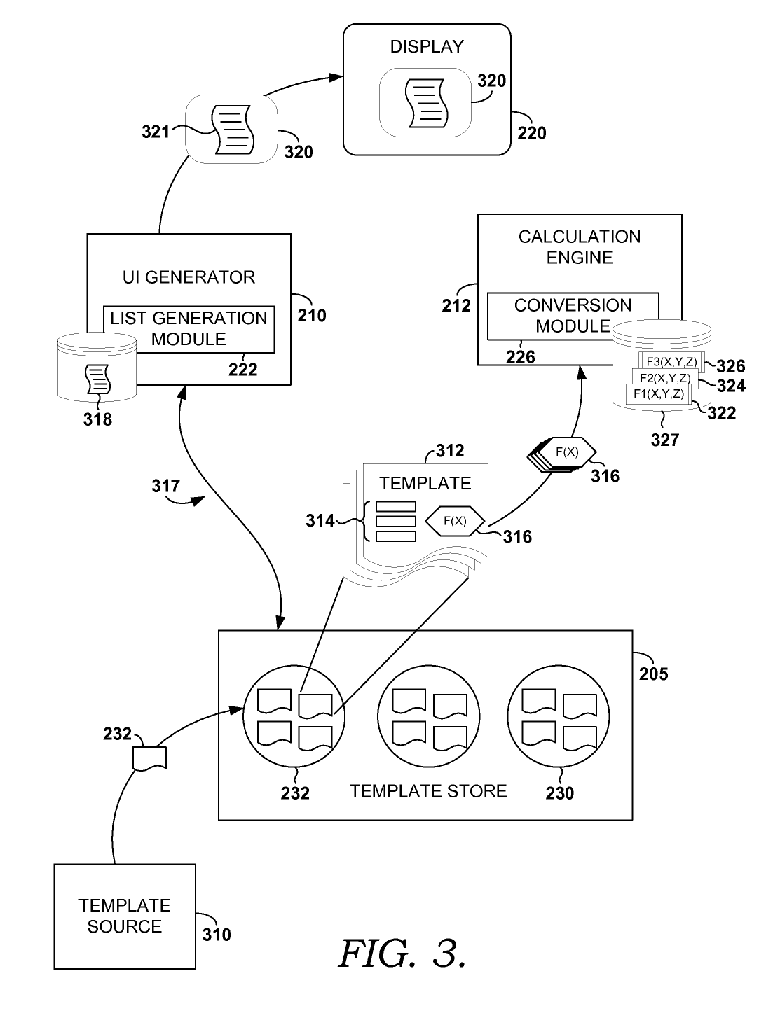

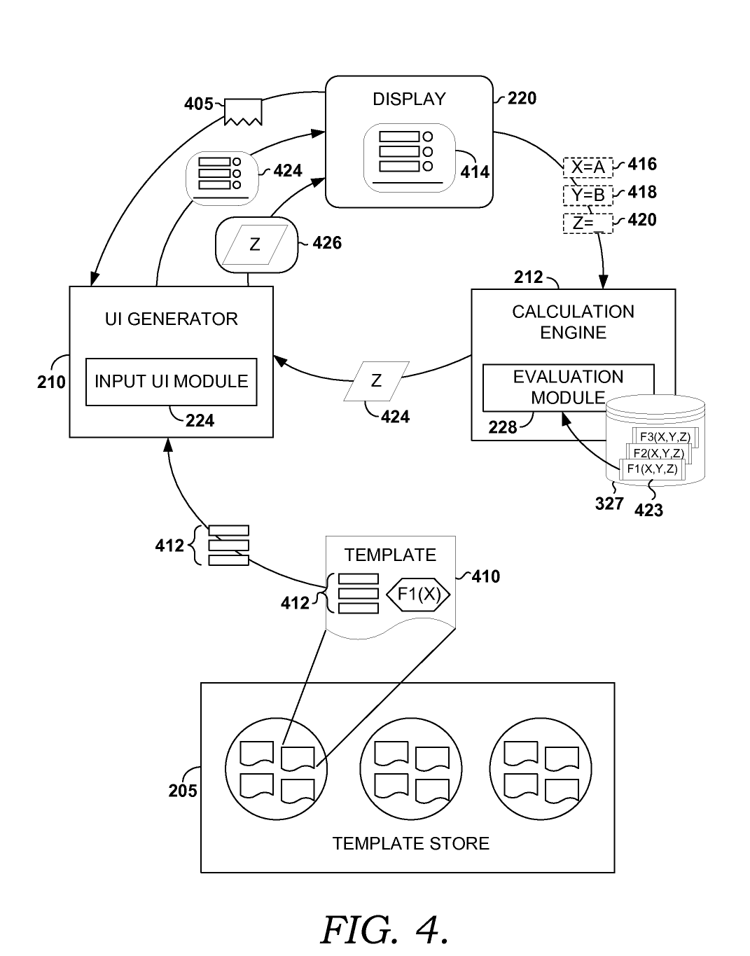

Turning now to FIGS. 3 and 4, schematic diagrams illustrating an exemplary implementation of the present invention are shown. One of ordinary skill in the art will recognize that many of the operations and processes described below with reference to FIGS. 3 and 4 may be facilitated, in various embodiments, by a template manager such as template manager 216 illustrated in FIG. 2. However, to provide a clear explanation of the processes involved, the template manager is not illustrated in FIGS. 3 and 4. Furthermore, the implementation illustrated in FIGS. 3 and 4 is merely an example of one suitable implementation and is not intended to suggest any limitation as to the scope of use or functionality of the present invention. Neither should the illustrated implementation be interpreted as having any dependency or requirement related to any single component or combination of components illustrated therein.

As illustrated in FIG. 3, a template store 205 is provided for storing built-in templates 230 and externally-defined templates 232. As discussed above with respect to FIG. 2, externally-defined templates 232 are obtained from a template source 310, which can include, for example, users, applications, plug-ins, storage media, and the like. As explained above with reference to FIG. 2, a template 312 defines a set of formulas representing a relationship between a given set of variables. For example, a template could be provided for calculating momentum that defines three formulas relating each of mass, velocity and momentum in terms of each of the other variables. In embodiments, templates can be grouped into different tool types based on shared similarities. For example, a statistics tool type could include templates that include formulas for working with lists of data, frequency counts, probabilities, and the like. In one embodiment, three types of tools are provided: statistics, unit conversions, and general.

According to various embodiments of the present invention, templates of a particular tool type can be further organized into groups based on logical similarities between them. This feature can assist in presenting templates to the user that are grouped in a logical fashion instead of providing a single long listing of available templates. Thus, in an embodiment, one category of templates might include templates for physics-related formulas such as momentum, energy, induction, and the like. Another exemplary category might include financial-related templates for calculating values such as simple interest, compound interest, annual percentage yield, and the like.

Template 312 includes the information necessary for UI generator 210 and calculation engine 212 to provide the functionality described herein. Templates can include files of any number of formats such as, for example structured file formats (e.g., XML) and binary file formats. Although alternate specifications for templates can be used to facilitate easy parsing of formula strings and the like, one example of an illustrative XML template definition file format follows:

```
<tool type=“UnitConversion”>
  <category name=“Length”>
    <displayName>Display for this whole category</displayName>
    <template name=“lengthformulas”>
      <displayName> length </displayName>
      <description> There are various units for length
      unit ...</description>
      <unitList>
        <unit name=“mm” type=“float”>
          <displayName>stringid.mm</displayName>
        </unit>
        <unit name=“cm” type=“float”>
          <displayName>stringid.mm</displayName>
        </unit>
        <unit name=“km” type=“float”>
          <displayName>stringid.mm</displayName>
        </unit>
        <unit name=“in” type=“float”>
          <displayName>stringid.mm</displayName>
        </unit>
      </unitList>
      <!-- function call: convert (Length, mm, cm, 80.4); convert
      (Length, cm, in, 80.4) -->
      <formulas hintBaseUnit=“cm”>
        <formula name=“mmTocm”toUnit=“cm” fromUnit=“mm”>
          <formulaString>mm * 10</formulaString>
        </formula>
        <formula name=“cmFromKm” toUnit=“cm” fromUnit=“km”>
          <formulaString>km * 100000</formulaString>
        </formula>
        <formula name=“QueenToMetric” toUnit=“cm” fromUnit=“in”>
          <formulaString>in * 2.4</formulaString>
        </formula>
        <formula name=“cmstomm” toUnit=“mm” fromUnit=“cm”>
          <formulaString>cm / 10</formulaString>
        </formula>
        <formula name=“kmsfromcm” toUnit=“km” fromUnit=“cm”>
          <formulaString>cm / 100000</formulaString>
        </formula>
        <formula name=“oldInchStuff” toUnit=“in” fromUnit=“cm”>
          <formulaString>cm / 2.4</formulaString>
        </formula>
      </formulas>
  </category>
</tool>
```

Upon instantiation of the calculator application represented by FIG. 3, user interface (UI) generator 210 accesses template store 205 to reference each template 312 stored therein, as indicated at reference numeral 317. UI generator 210 can access template store 205 by way of any number of various types of communications, interfaces, and the like. For example, in one embodiment, UI generator queries template store 205 for templates 312. In some embodiments, UI generator can access templates 312 in template store 205 via a template manager.

As illustrated in FIG. 3, UI generator 210 includes a list generation module 222 such as the list generation module 222 described above, with reference to FIG. 2. List generation module 222 references template 312 to ascertain information contained in template 312. For example, list generation module 222 retrieves input field characterizations 314 from template 312, the name of the template 312, and an identification of a formula 316 embodied in template 312. In some embodiments, list generation module 222 can retrieve this information by directly referencing template 312, whereas in other embodiments, a template manager can parse template 312 and provide the resulting information to list generation module 222. In an embodiment, upon obtaining the necessary information from template 312, list generation module 222 constructs a table or other suitable data structure containing a mapping 318 between formula identifiers and template names. The mapping 318 can be stored or cached by list generation module 222 such that listings of templates can be available throughout a calculator session without having to regenerate the listing each time it is to be provided to a user.

UI generator 210 reads the mapping 318 and generates a user interface (UI) 320 that includes a listing 321 of template names, which may or may not be identical to formula identifiers. The UI 320 is provided to a user by way of a display 220. In this manner, the user can view the listing 321 of available templates for calculation and select a desired template. In the meantime, as illustrated in FIG. 3, calculation engine 212 also prepares for the calculator session by referencing templates 312. Calculation engine 212 includes a conversion module 226 that exposes a function that takes as input a formula string 316 from template 312 and replaces the template calls in the string with formula expansions 322, 324, and 326. As described above with respect to FIG. 2, conversion module 226 can be adapted to interpret templates within other templates, e.g., formulas that take as input answer values from other formulas. Converted formulas 322, 324, and 326 are stored or cached in storage 327 associated with calculation engine 212 such that they are available throughout the duration of a calculator session.

The exemplary calculator experience is further illustrated in FIG. 4. As illustrated therein, UI generator 210 receives a template selection 405. Template selection 405 can be provided by a user and interpreted by input UI module 224 such that the appropriate corresponding template 410 can be referenced. As illustrated in FIG. 4, UI generator references template 410 to ascertain or extract input field characterizations 412. Input field characterizations 412 can include definitions of the associated variables, information regarding the manner in which the input fields are to be displayed, information regarding types of valid input that can be accepted via the input fields, and the like. Using input field characterizations 412, input UI module 224 generates a user interface (UI) 424 that includes input fields, associated names of input fields, units associated with the input fields, and the like. UI generator 210 causes display 220 to render UI 424 such that the user is provided with UI 424 and can thus interact with UI 424 to provide input values 416 and 418 for calculation.

As further illustrated in FIG. 4, input values 416 and 418 are received by calculation engine 212 from the user and are associated with the appropriate input fields. Additionally, an indication 420 of a variable that is to be calculated (i.e., an input field that is left blank or selected for calculation such as by activation of a radio button associated therewith) is received by calculation engine 212. In various embodiments, an instruction to perform the calculation can be received by calculation engine 212. For example, a user may click on a button or perform a keystroke that causes an instruction to calculate to be communicated to calculation engine 212. Upon receiving an instruction to calculate, each input field is checked to determine whether the input value 416, 418 is valid. It will be recognized by those of ordinary skill in the art that a variety of rules can be implemented for determining valid input values and that validity rules may vary between tools and/or categories of templates. Additionally, if an input value 416 or 418 is determined to be invalid, various techniques known in the art can be employed to notify the user of the invalid input.

Based on attributes or other characteristics associated with input 416, 418, and 420, calculation engine 212 determines the appropriate formula 423 that corresponds to the input 416, 418, and 420. The formula 423 is retrieved from storage 327 and provided to evaluation module 228. Evaluation module 228 evaluates formula 423 based on user input 416 and 418 to determine an answer value 424 corresponding to variable 420. As illustrated in FIG. 4, answer value 424 is referenced by UI generator 210 to generate a displayable representation 426 of answer value 424, which is rendered on display 220. Additionally, although not illustrated in FIGS. 3 and 4, any of the user inputs 416 and 418 and the answer value 424 can be temporarily stored or cached such that a user can access the values at a later time during the calculator session such as, for example, to use the values in a subsequent calculation.

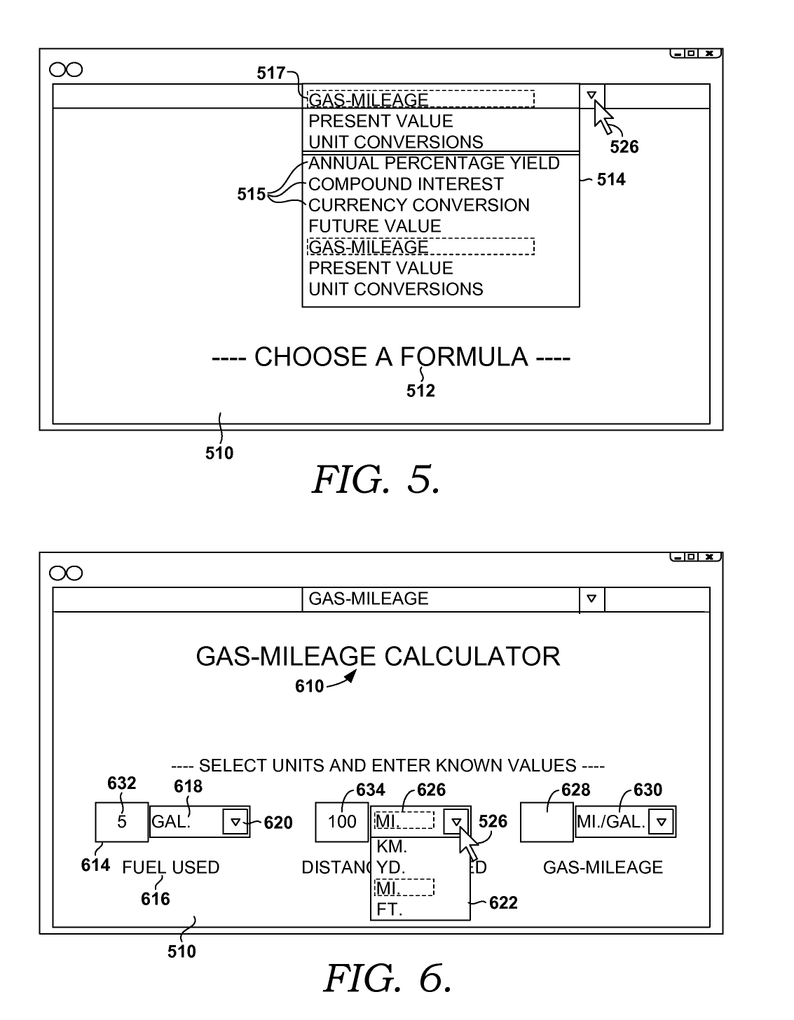

Turning now to FIGS. 5-8, an exemplary user interface (UI) experience in accordance with an embodiment of the present invention is depicted. As illustrated in FIG. 5, an illustrative UI 510 in accordance with embodiments of the present invention includes a first screen 512 (or first UI) for choosing a formula. A drop-down menu 514 is provided by activating a button using a mouse cursor 526. Other mechanisms for providing a listing of formulae can be used in accordance with embodiments of the present invention. The drop-down menu 514 includes various formula identifiers 515, each of which corresponds to a template having a formula embodied therein. The user selects the desired formula identifier 517, which is subsequently displayed in a tool bar above the drop-down menu 514.

In the illustrated example, the user has selected a gas-mileage calculation identifier 517, as shown in FIG. 5. Turning to FIG. 6, in response to the user's selection, a gas-mileage calculation screen is provided on the UI 510. The UI 510 includes a name identifying the corresponding formula from the template associated with the selected formula identifier 517. As further illustrated in FIG. 6, UI 510 includes several input fields 614, each of which is accompanied by a label 616 and a units field 618. In the embodiment illustrated in FIG. 6, the units field can include a clickable button 620 for providing a drop-down list 622 that includes alternative options for the units from which a user can choose. In embodiments, the calculator application described herein can be adapted to automatically convert inconsistent units to consistent units before calculation, thus allowing a user to enter values corresponding to any of the units available. Thus, for example, the user could provide a first input value 632 for fuel used as a measure of gallons and a second input value 634 for distance traveled as a measure of kilometers and still receive an answer value in field 628 in terms of miles per gallon.

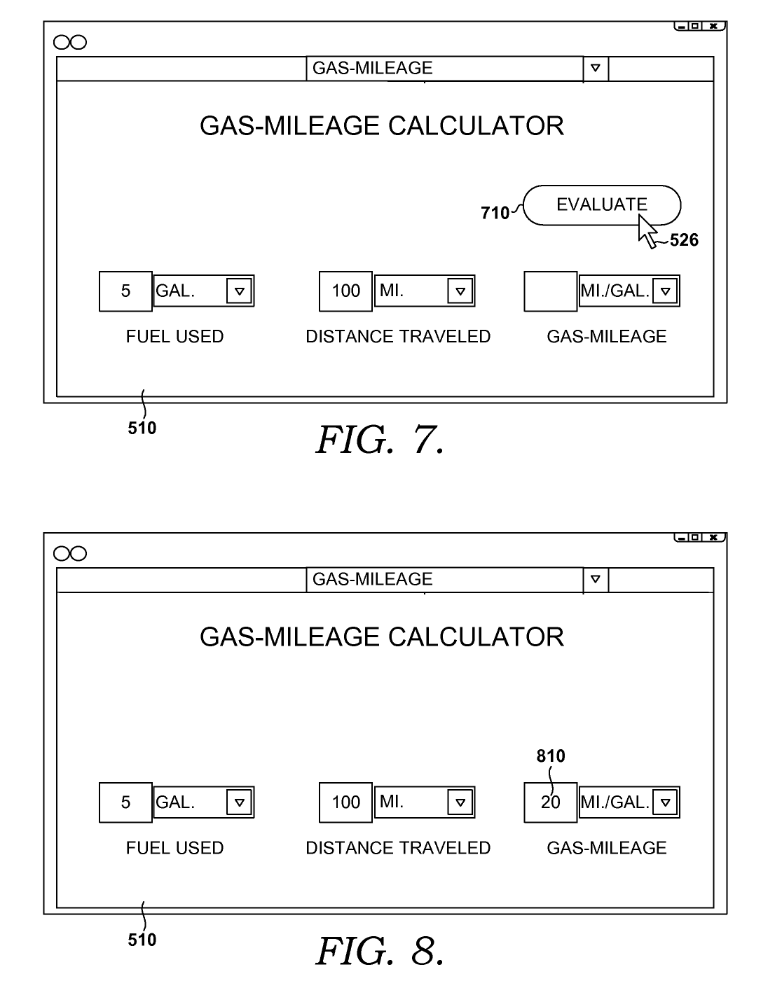

Turning to FIG. 7, after a user has entered known input values, the user can click on a calculate button 710 to initiate the process of determining the answer value. As illustrated in FIG. 8, the answer value 810 is displayed in the input field associated with the gas-mileage label. In various embodiments, the answer value can be displayed, as illustrated, within the same UI 510 containing the other input fields. In other embodiments, answer value 810 can be displayed on a separate UI. Additionally, the UI 510 depicted in FIGS. 5-8 is only an example of a UI suitable for implementations of the present invention and may be configured in any number of various manners to facilitate a user's calculator experience.

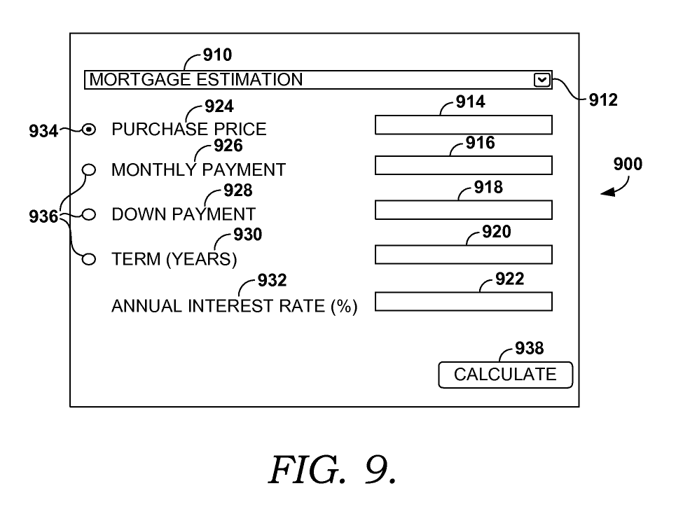

Turning to FIG. 9, another exemplary UI is illustrated. FIG. 9 depicts an exemplary UI 900 associated with a mortgage estimation calculation in accordance with an embodiment of the present invention. The UI 900 includes a box 910 that supports a drop-down menu (not shown) accessible via button 912. The drop-down menu includes a listing of all available templates. In embodiments, the available templates are represented by template names, and in other embodiments, the available templates can be represented by formula identifiers. As mentioned above, in some embodiments, template names and formula identifiers can be the same, as well. Further, according to some embodiments, the exemplary template 900 can be essentially the same for different formulas—upon receiving a different template choice from the user, the fields will change according to the chosen template. Additionally, in some embodiments, the templates can retain the values in the fields during a calculator session. Thus, for example, if a user uses the mortgage estimation template, switches to another template, and comes back, the previous values in the fields for the mortgage estimation will remain in those fields.

As further illustrated in FIG. 9, UI 900 includes input fields 914, 916, 918, 920, and 922 and corresponding labels 924, 926, 928, 930, and 932. Each of the pair of input fields 914, 916, 918, 920, and 922 and labels 924, 926, 928, 930, and 932 corresponds to a variable defined in an associated template. For example, in the illustrated embodiment, information in the template corresponding to the mortgage estimation UI 900 defines the variables, parameters and the formulas that describe the relationships between those variables and parameters. In this example, input field 914 corresponds to purchase price (P), input field 916 corresponds to monthly payment (R), input field 918 corresponds to down payment (D), input field 920 corresponds to term (t), and input field 922 corresponds to the annual interest rate (r). Further, for example, the following parameter can be defined within the template: the number of periods per year (m=12). Intermediate functions may also be defined within the template. Intermediate functions defined for the mortgage calculation UI include the following:

$$i = \frac{r}{m} and n = tm .$$

Using the defined parameters and intermediate formulas, the calculation engine can evaluate the formula for the variable corresponding to the target value selected by the user. Thus, if the user selects, as illustrated in FIG. 9, to calculate purchase price (P), the calculation engine evaluates the following expression, incorporating the defined parameters and intermediate formulas:

$$P = R [ \frac{1 - \frac{1}{{( 1 + i )}^{n}}}{i} ] + D .$$

The answer value, P, is provided to the user on the display. If the user selects to calculate monthly payment, however, the calculation engine evaluates the following expression, incorporating the defined parameters and intermediate formulas:

$$R = \frac{( P - D ) i}{[ 1 - \frac{1}{{( 1 + i )}^{n}} ]} .$$

As discussed above, sometimes the calculation engine must evaluate an intermediate formula before evaluating the primary formula. For example, the mortgage estimator UI can determine the term in years by first calculating

$$n = \frac{log [ \frac{1}{1 - \frac{( P - D ) i}{R}} ]}{log [ 1 + i ]} ,$$

and then using the intermediate answer value for n in the following formula:

$$t = \frac{n}{m} .$$

In an embodiment, as illustrated, each field that can be calculated has a radio button 934, 936 associated with it. Those fields (i.e., annual interest rate 932 in the illustrated embodiment) that cannot be calculated do not have an associated radio button. The user can select the radio button 934 associated with the field 914 that the user wishes to calculate. The user leaves that field 914 blank, and an answer value representing the variable associated with the blank field 914 will be determined by the calculator application. In an embodiment, upon choosing a radio button 934, the associated input field will become read-only. UI 900 further includes a “CALCULATE” button 938 that the user can click after providing input values to the remaining fields 916, 918, 920, and 922 to begin the calculation process. Once the answer value is determined, it will be provided in field 914.

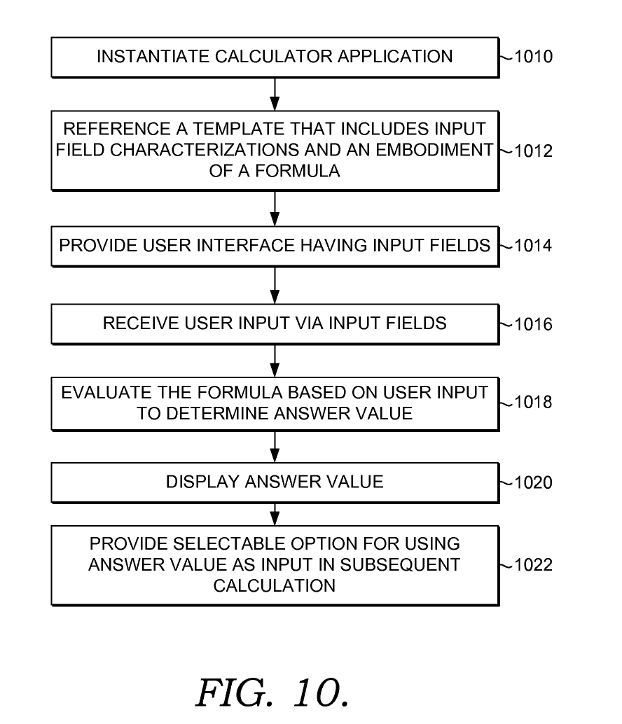

To recapitulate, we have described systems and methods for using a calculator application to calculate an answer value by applying a formula embodied in a template. Turning to FIG. 10, a flow diagram is provided, showing an illustrative method of providing such a calculator experience to a user. At an illustrative first step, step 1010, the user instantiates a calculator application such as the application described herein. At a step 1012, the calculator application references a template that includes input field characterizations and an embodiment of a formula.

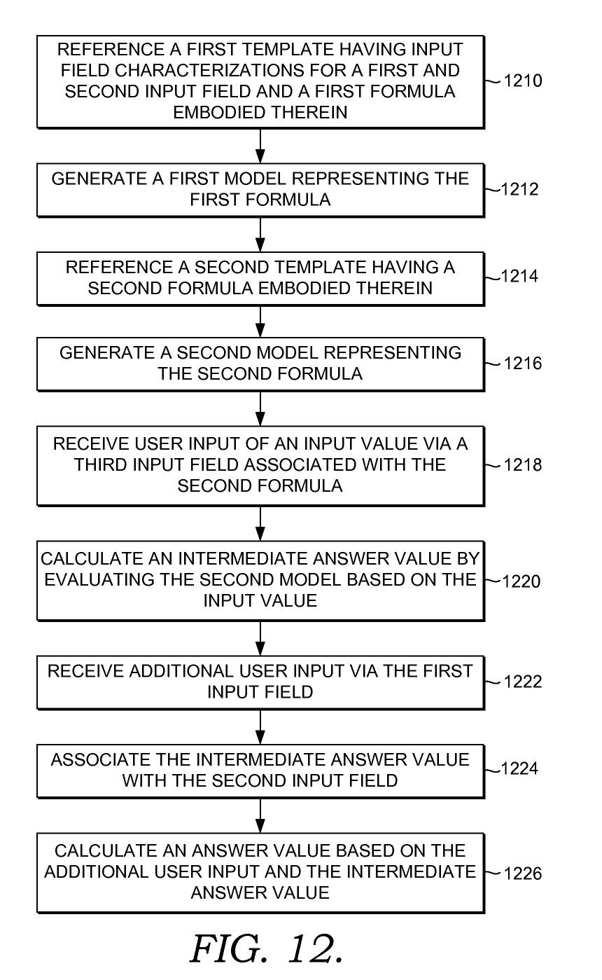

At step 1014 of FIG. 10, a user interface is provided to a user. The user interface includes input fields and, as shown at step 1016, user input is received via the input fields. At step 1018, the formula is based on user input to determine an answer value. The answer value is then displayed to the user, as illustrated at step 1120. Again, as illustrated at FIG. 12, a selectable option for using the answer value in subsequent calculations as an input value.

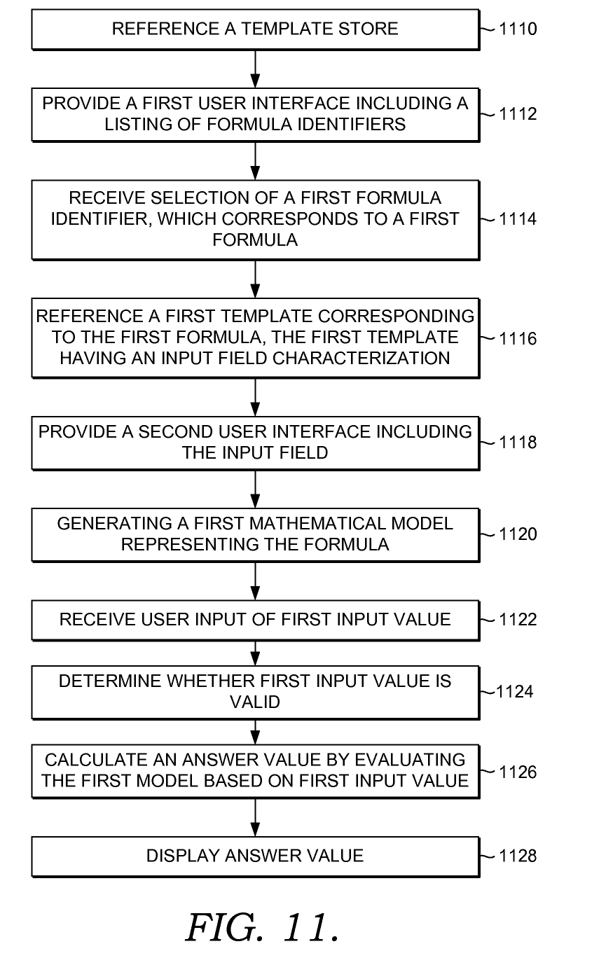

Turning to FIG. 11, a flow diagram is provided, showing an illustrative method of providing template-based calculations to a user of a computing device. At an illustrative first step, step 1110, a template store is referenced to generate a first user interface. The first user interface is provided, as shown at step 1112, and includes a listing of formula identifiers. At step 1114, a selection of a first formula identifier is received. The first formula identifier corresponds to a first formula, which is embodied within a template. At step 1116, a first template that includes an input field characterization corresponding to the first formula is referenced.

With continued reference to FIG. 11, at step 1118, a second user interface is provided. In an embodiment this second user interface includes the input field. Further, at step 1120 a first mathematical model representing the formula from the first template is generated. In an embodiment, this model can be cached or stored in storage for subsequent uses. As indicated at step 1122, user input is received that provides a first input value and, at step 1124, a determination is made whether the first input value is valid. If the input value is not valid, the user interface can provide an error message. If, on the other hand, the input value is valid, an answer value is calculated, as shown at step 1126. The answer value is calculated by evaluating the first model based on the first input value. At a final illustrative step, step 1128, the answer value is displayed.

Turning now to FIG. 12, a flow diagram showing another illustrative method of providing template-based calculations to a user of a computing device. At step 1210, a first template is referenced. The first template includes input field characterizations for a first and second input field. Additionally, there is a first formula embodied within the template. At step 1212, a first model is generated to represent the first formula. The first model can be cached or stored by the calculator application such as, for example, throughout the entire calculator session. At step 1214, a second template is referenced. The second template includes a second formula and at least one third input field characterization. At step 1216, a second model representing the second formula is generated.

With continued reference to FIG. 12, and particularly step 1218, user input of an input value is received by way of the third input field, which is defined by the second template. An intermediate answer value is calculated by evaluating the second model based on the input value, as shown at step 1220. In some embodiments, the intermediate answer value can be cached or stored for subsequent calculations. At step 1222, additional user input is received via the first input field and at step 1224, the intermediate answer value is associated with the second input field. At a final illustrative step 1226, an answer value is calculated based on the additional user input and the intermediate answer value.

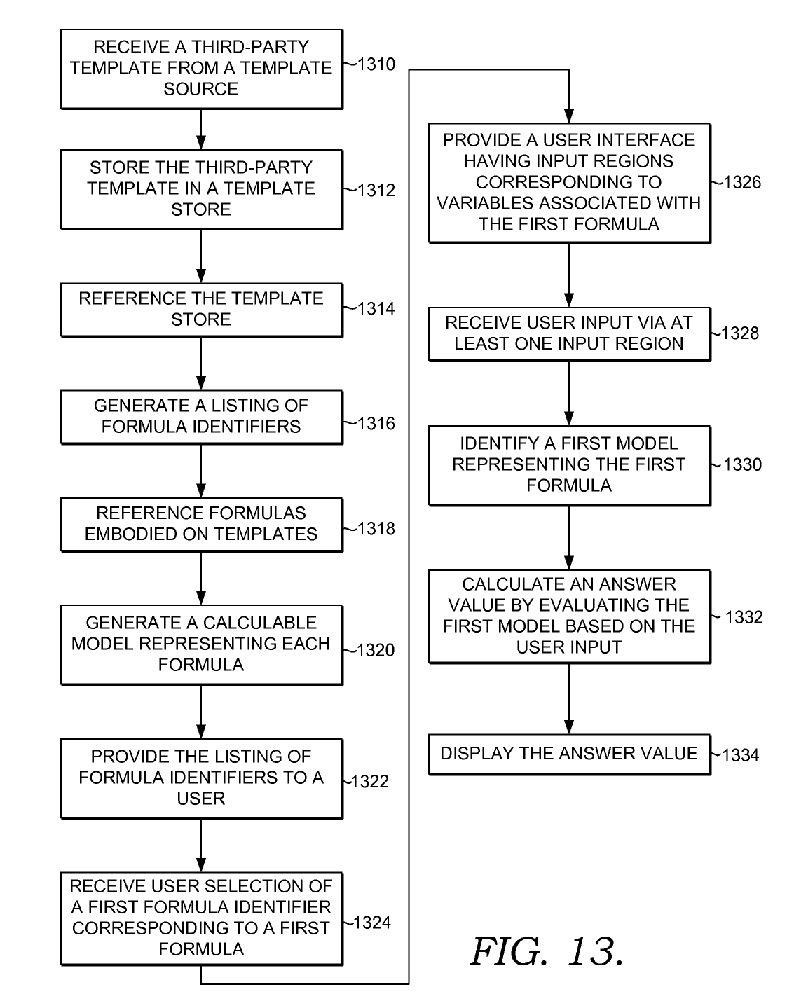

FIG. 13 is a flow diagram showing an illustrative method of using a calculator application to calculate an answer value by applying a formula having at least one variable according to input received from a user. At a first illustrative step 1310, a third-party template is received from a template source. The third-party template is stored in a template store at step 1312. At step 1314, a listing of formula identifiers is generated and at step 1316, formulas embodied on the templates are referenced. Upon referencing the formulas, a calculable model representing each formula is generated, as shown at step 1320.

As illustrated at step 1322, a user is provided with a listing of formula identifiers and at step 1324, a user selection of a first formula identifier is received. The first formula identifier corresponds to a first formula. Thereafter, at step 1326, the user is provided with a user interface that includes input regions corresponding to variables associated with the first formula. The user can input values for a number of the variables, and that input is received via at least one input region, as shown at step 1328. Based on the user input, a first model representing the first formula is identified at step 1330. Then, at step 1332, an answer value is calculated by evaluating the first model based on the user input. At a final illustrative step, 1334, the answer value is displayed.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

For example, in one alternative embodiment, indications may be provided on the user interface that assist the user in determining which values the user has modified after running a calculation. For example, after a user modifies a value in an input field, the label associated with the input field can include an asterisk ‘*’ or other character that indicates that the value in that input field has been changed since last referenced by the calculator application during a calculation. Thereafter, the user might enter or modify additional input fields and select a radio button associated with an input field to indicate that the associated field is to be calculated. After instructing the calculator to perform the calculation, any asterisks associated with input fields will then be removed.

In another embodiment, the calculator application can be adapted to provide feedback with respect to the validity of input values provided by users. For example, after a user provides input values to input fields and instructs the calculator application to perform the calculation, each input field is checked for valid input values. If there are invalid input values, the system can display a bubble message for the top-most field that contains an invalid input value. In an embodiment, the cursor can automatically be placed in that field as well. The user can then enter a valid input value and attempt the calculation again. According to embodiments, this process can be repeated until all of the input values are valid. In another embodiment, if there is an error during calculation, the field marked for calculation is cleared and a bubble message is displayed on or adjacent to that field that includes an error message notifying the user that the calculation was unable to be performed.

It will be understood that certain features and subcombinations are of utility and may be employed without reference to other features and subcombinations and are contemplated within the scope of the claims. Not all steps listed in the various figures need be carried out in the specific order described.

The invention claimed is:

1. One or more computer-readable media having computer-executable instructions embodied thereon for performing a method of using a calculator application to calculate an answer value by applying a formula having at least one variable according to input received from a user, the method comprising:
instantiating a calculator application on a computing device having an operating system, wherein the calculator application comprises an independent application hosted by the operating system;
providing a user interface adapted to facilitate user interaction with the calculator application, the user interface comprising an input field for receiving user input, wherein providing the user interface comprises referencing a template having a characterization of the input field and having an embodiment of the formula;
receiving user input via the input field, the user input specifying a value of a first variable;
evaluating the formula, based on the user input, to determine an answer value that corresponds to a second variable; and
displaying the answer value.

2. The media of claim 1, wherein the user interface further comprises a label associated with the at least one input field, the label identifying the variable associated therewith.

3. The media of claim 1, wherein the template comprises an XML file.

4. The media of claim 1, wherein the formula comprises a mathematical relationship between the first variable and the second variable.

5. The media of claim 1, further comprising providing a template store interface that allows the user to manage the templates in the template store.

6. The media of claim 5, wherein managing the templates comprises at least one of adding, deleting, and modifying a template.

7. The media of claim 1, wherein displaying the answer value further comprises providing a selectable option for using the answer value as input in a subsequent calculation.

8. The media of claim 1, further comprising displaying a listing of formula identifiers, each of the formula identifiers corresponding to a formula that defines a relationship between a plurality of variables.

9. The media of claim 8, further comprising receiving a user selection of a formula from among the listing of formula identifiers.

10. The media of claim 9, wherein the formula comprises a reference to an additional template.

11. One or more computer-readable media having computer-executable instructions embodied thereon for performing a method of using a computing device having an operating system to calculate an answer value by applying a formula having at least one variable according to input received from a user, the method comprising:
providing a first user interface comprising a listing of a plurality of formula identifiers, each of the plurality of formula identifiers corresponding to a formula that defines a relationship between a plurality of variables, wherein the listing of formula identifiers is generated by referencing a template store hosted by the operating system;
receiving a selection of a first formula identifier from the listing, the first formula identifier corresponding to a first formula;
referencing a first template that corresponds to the first formula, the first template comprising an embodiment of the first formula and a characterization of a first input field corresponding to a first variable, wherein the first input field is adapted to receive user input that assigns a value to the first variable;
providing a second user interface comprising the input field;
generating a first model that represents the formula, wherein the first model can be evaluated to calculate an answer value;
receiving user input by way of the first input field, the user input comprising a first input value;
calculating an answer value by evaluating the first model based on the first input value; and
displaying the answer value.

12. The media of claim 11, wherein the first template comprises an XML file.

13. The media of claim 11, wherein generating the model comprises referencing a second template, wherein the first formula comprises a second input field associated with a value that can be ascertained by calculating a second formula embodied on the second template.

14. The media of claim 13, wherein referencing the second template comprises:
generating a second model that represents the second formula, wherein the second model can be evaluated to calculate an intermediate answer value;
receiving user input by way of a third input field associated with the second formula, the user input comprising a second input value; and
calculating an intermediate answer value by evaluating the second model based on the second input value.

15. The media of claim 13, wherein at least one of the first and second templates is created by a user.

16. The media of claim 13, wherein at least one of the first and second templates is received from an application.

17. One or more computer-readable media having computer-executable instructions embodied thereon for performing a method of using a calculator application to calculate an answer value by applying a formula having at least one variable according to user input, the method comprising:
receiving a third-party template from a template source, wherein the third-party template comprises a characterization of a first input field that corresponds to a first variable and an embodiment of a formula that represents a relationship between the first variable and a second variable;
storing the third-party template in a template store that maintains a plurality of templates, wherein each of the plurality of templates comprises an embodiment of a formula and a characterization of an input field;
referencing the template store;
generating a listing of formula identifiers, each of the formula identifiers corresponding to a formula embodied on one of the plurality of templates;
generating a plurality of models, each model comprising a calculable representation of a formula, wherein generating each of the plurality of models comprises referencing a formula;
providing the listing of formula identifiers to a user;
receiving a user selection of a first formula identifier corresponding to a first formula;
providing a user interface comprising a plurality of input regions for receiving user input, wherein each of the plurality of input regions corresponds to a variable associated with of the first formula;
receiving user input via at least one of the plurality of input regions;
identifying, based on an attribute associated with the at least one input region, a first model that represents the first formula;
calculating an answer value, wherein calculating an answer value comprises evaluating the first model based on the user input; and
displaying the answer value.

18. The media of claim 17, wherein receiving user input via at least one of the plurality of input regions comprises receiving user input via all but one of the plurality of input regions, wherein the one input region is left blank.

19. The media of claim 18, further comprising identifying the blank input region as corresponding to a variable whose value is to be calculated.

20. The media of claim 19, further comprising storing information about the user input and blank input region in a cache to facilitate learning behavioral patterns associated with the user.
